(19) United States
(12) Patent Application Publication
(10) Pub. No.: US 2019/0003464 A1
(43) Pub. Date: Jan. 3, 2019

(54) Centering a Line in a Rotating Shaft

(71) Applicant: SENVION GmbH, Hamburg (DE)

(72) Inventor: Mirko Kaßner, Preetz (DE)

(21) Appl. No.: 16/023,118

(22) Filed: Jun. 29, 2018

(30) Foreign Application Priority Data
Jun. 30, 2017 (DE) 10 2017 006 193.9

(51) Int. Cl. F03D 80/80

(52) U.S. Cl. CPC F03D 80/85; F05B 2240/21; F05B 2240/61

(57) ABSTRACT

The device for centering a line in a rotating hollow shaft comprises a tube, the wall of which is slotted over the entire tube length, substantially parallel to the tube axis, and which can be deformed for the temporary widening of the slot for the radial introduction of a line into the tube. Bristle tufts distributed in the longitudinal and circumferential direction are arranged on the outer side of the tube for support on the inner wall of the rotating hollow shaft. In the wind turbine having a rotor rotatably supported on a gondola around a rotor shaft formed as a hollow shaft, wherein at least one line is led from the rotor through the rotor shaft to the gondola, the line guidance in the rotor shaft is implemented as an arrangement according to the invention.

### BACKGROUND

The invention relates to a device for centering a line in a rotating shaft, an arrangement of a line in a rotating shaft comprising such a device, and a wind turbine with corresponding arrangement.

In systems having two parts rotating relative to each other, it is regularly necessary to produce line connections between the two parts in order, for example, to permit electric power or signal transmission. The corresponding lines are regularly lead through the shafts provided for the rotation to a slip ring arrangement, where, via an arrangement of one slip ring assigned to one part of the system and a receiver (for example a carbon brush) resting on the slip ring and assigned to the other part of the system, an electrical connection is produced between the two parts of the plant. For hydraulic lines, recourse is often had to a cascade of rotary couplings arranged congruently with the shaft axis.

One example of systems having two parts rotating relative to each other, between which line connections have to be created, is wind turbines. In known wind turbines, a rotor rotatable about a substantially horizontal axis and having rotor blades arranged thereon is set rotating by wind. The rotor is mounted with a rotor shaft in a gondola and is connected—if necessary via a gear mechanism—to a generator to convert the rotational energy of the rotor into electrical energy. In modern wind turbines, there are diverse electrically and/or hydraulically operated components in the rotor itself (for example sensors or blade adjusting drives), which have to be connected electrically and/or hydraulically via the rotor shaft to control and supply components in the non-rotating gondola. For this purpose, the lines are led through the rotor shaft, designed as a hollow shaft, to a transfer point—for example a slip ring arrangement or rotary couplings.

Co-rotating lines led through rotating shafts are subjected to fundamentally flexing movements on account of the force of gravity acting on the same, since, because of friction on the inner wall of the shaft, they are initially moved with the rotating shaft over a certain distance but then fall down again under the force of gravity. The line sheaths are rubbed away over time, which requires regular replacement of the lines in order to prevent a failure of the line and thus possibly of the system as a whole. In addition, the continuous movement in the case of electric lines can lead to cable fractures, which likewise regularly require a stoppage of the system and a line replacement. Not least, the movements can be propagated into axial movements at the line ends, which can impede a reliable connection of the lines.

### SUMMARY OF THE INVENTION

It is an object of the invention to devise a device in which the problems known from the prior art can no longer occur or occur only to a reduced extent.

This object is achieved by a device according to the main claim and an arrangement and a wind turbine according to the subordinate claims.

Accordingly, the invention relates to a device for centering a line in a rotating hollow shaft comprising a tube, the wall of which is slotted over the entire tube length, substantially parallel to the tube axis, and which can be deformed sufficiently for the temporary widening of the slot for the radial introduction of a line into the tube, wherein bristle tufts distributed in the longitudinal and circumferential direction are arranged on the outer side of the tube are arranged for support on the internal diameter of the rotating hollow shaft.

Furthermore, the invention relates to an arrangement comprising a hollow shaft and at least one line led through the hollow shaft, wherein the at least one line is guided in the tube of a device according to the invention that is arranged in the hollow shaft.

The invention also relates to a wind turbine having a rotor rotatably supported on a gondola around a rotor shaft formed as a hollow shaft, wherein at least one line from the rotor is led through the rotor shaft to the gondola, and wherein the line guidance in the rotor shaft is implemented as an arrangement according to the invention.

In connection with the device according to the invention, reference is variously made to the “internal diameter of the rotating hollow shaft”, which itself is not an element of the device according to the invention. However, the proper use of the device according to the invention includes the arrangement of the same in a hollow shaft, wherein it is a matter of the correct ratio of the dimensions of the device to the internal diameter of the hollow shaft. The reference to the “internal diameter of the rotating hollow shaft” is therefore a nominal diameter co-determining the dimensions of the device according to the invention, which is designated as the internal diameter of the rotating hollow shaft merely for reasons of better comprehensibility.

With the aid of the device according to the invention, it is possible to center one or more lines in a rotating shaft is such a way that the flexing movement of the lines known from the prior art and the associated disadvantages can be avoided or at least considerably reduced. The line(s) is/are arranged in a tube, which has an internal diameter which is considerably smaller as compared with the internal diameter of the rotating shaft, so that the flexing movement of the lines arranged therein is at least considerably reduced. However, it is preferred if the internal diameter of the tube is matched to the external diameter and/or the number of lines in such a way that the lines within the tube no longer execute any relative movements during the rotation.

In order to be able to introduce the lines simply into the tube or, if necessary, to remove individual lines again (for example to replace a defective line), the wall is slotted over the entire tube length, substantially parallel to the tube axis. This slot can be widened as necessary, so that at least respectively one line can be introduced or removed in the radial direction of the tube. “Substantially” in this connection means that the longitudinal direction of the slot deviates by less than 5 degrees, preferably by less than 3 degrees, further preferably by less than 1 degree, from the longitudinal axis of the tube. The slot can also be completely parallel to the longitudinal axis of the tube, which means that particularly simple and therefore inexpensive production of the tube and of the slot is possible.

In order that said widening is possible, of course after the slot must be closed again in order to keep the lines in the interior of the tube, in a preferred embodiment the tube can be configured to be sufficiently elastic, so that the widening of the slot can be achieved solely by elastic formation of the tube. This embodiment offers the advantage that the slot fundamentally closes automatically again. In addition, the elastic deformability can be used to secure the lines in the interior of the tube against a relative movement with respect to the tube, by means of a clamping action. For this purpose, the tube internal diameter should be chosen to be somewhat smaller than the external diameter of the lines to be accommodated or the line bundle to be accommodated.

However, it is also possible, for example, to provide a hinge device—for example a film hinge—extending over the length of the tube, via which the tube can be folded open in order thus to widen the slot. Finally, it is also possible to provide the tube with a second longitudinal slot, so that it can be broken down into two parts in order thus “to widen” both slots and to introduce the lines into the tube; the two parts of the tube are then led together again. In particular in these two cases, it is preferable if the device comprises securing elements with which unintended widening of the slot(s) is prevented. The securing elements can comprise, for example, latching elements or flanges for screw fixing.

In all the aforementioned embodiments, care must be taken that the device comprises a tube in which, although widening of the longitudinal slot as necessary is to be made possible, at the same time it also has a rigidity maintaining the fundamental tubular shape.

The tube itself is supported, via the bristle tufts arranged on the tube outer side, on the inner wall of the rotating hollow shaft in which the device is inserted during use. The free ends of the bristle tufts rest on the inner wall of the rotating hollow shaft and each comprise bristles that are sufficiently stiff to carry the weight of the tube and the lines contained therein. As a result, the tube of the device according to the invention can be kept centrally in the rotating hollow shaft. Of course, this assumes that the bristle tufts comprise an adequate number of bristles and these overall have an adequate rigidity to carry the tube with the lines supported therein. However, it is also readily possible for those skilled in the art to find a suitable bristle tuft configuration.

It is preferred if the external diameter of the device defined by the free ends of the bristle tufts corresponds at least to the internal diameter of the rotating hollow shaft—or the nominal diameter of the device—, is preferably larger by at least 5%, further preferably by at least 10%, than the internal diameter of the rotating shaft. In other words, the diameter of the circumcircle around the bristle tufts should at least correspond to the internal diameter of the hollow shaft, so that during a rotation of the hollow shaft the bristle tufts can also reliably ensure centering of the tube. It is even preferred for the diameter of the circumcircle to be larger by about 5%, further preferably by about 10%, than the internal diameter of the rotating hollow shaft. In this case, following the insertion of the device into the hollow shaft, at least some of the bristles are bent and thus rest on the inner wall of the hollow shaft such that a spring action results. As a result, possible vibrations, which could result in the line(s) located in the tube rubbing on one another and/or on the tube itself, are at least partly kept away from the tube. In addition, a certain tolerance with respect to exceeding the intended dimension for the internal diameter of the hollow shaft can be achieved.

Provision can also be made for the bristle tufts to be arranged at an angle not equal to 90° with respect to the outer side of the tube, wherein the bristles are preferably inclined counter to an expected direction of movement. By means of an appropriate arrangement, introduction of the device into a hollow shaft can be made easier if the introduction is carried out in the specified direction of movement of the device.

It is preferred if the bristle tufts are arranged to be distributed regularly over the length and/or the circumference of the tube. For example, the bristle tufts can be arranged at the junction points of a virtual grid placed over the outer side of the tube. An appropriate arrangement results in regularly bristle tuft-free sections in the longitudinal direction of the device, at which, for example, individual segments of the tube together with the bristle tufts arranged thereon can be severed in order to shorten the device to a desired length. It is also possible for cable ties to be arranged in appropriate regions, with which cable ties the tube can be fixed with respect to the lines arranged therein and can be secured against inadvertent widening of the slot. It is of course also possible that corresponding bristle tuft-free sections are provided without any regular arrangement of the bristle tufts.

It is preferred if the tube has at least one tapering region on its inner side, extending over the entire length of the tube and parallel to the tube longitudinal axis. By means of such a tapering region, for example, a film hinge can be created. By means of an appropriate tapering region, however, an elastic flexibility of the tube for the widening of the longitudinal slot as necessary can be ensured even when the tube otherwise has a wall thickness that is too large for the desired flexibility, for example in order to be able to fix the bristle tufts in the wall. If multiple tapering regions are provided, these are preferably distributed symmetrically and/or uniformly over the circumference of the tube.

It is preferred if all the edges on the inner side of the tube are de-burred and/or provided with radii. In addition to the edges in the region of the longitudinal slot, all the edges in conjunction with tapering regions also covered thereby. If sharp edges on the inner side of the tube are avoided, the risk of damage to a line accommodated in the tube is reduced.

Preferably, connecting elements for connecting the device to an immediately adjacent device in the axial direction to form a composite are provided on the outer and/or end side of the tube. By means of appropriate connecting elements, a composite of any desired length comprising devices according to the invention can be achieved, wherein the individual devices can continue to have an easily handled length. The connecting elements can be configured as parts of a conical seat or parts of a latching connection, which can cooperate with corresponding parts of an adjacent device.

The tube of the device can be produced in the extrusion process or as an injection molding of plastic and then provided with bristle tufts. For the above-described embodiment, in which the widening of the slot is achieved by elastic deformation of the tube, the plastic is preferably sufficiently elastic.

In an exemplary embodiment, the internal diameter of the tube is 32 mm, the wall thickness of the tube being around 4.5 mm. The bristle brushes are arranged at right angles to the outer wall of the tube and have bristles with lengths of about 22 mm. A device having the dimensions of this exemplary embodiment is therefore suitable for use in hollow shafts with an actual internal diameter of up to 85 mm; the device according to this example can regularly be used also up to an internal diameter of the hollow shaft of 80 mm. All the aforementioned dimensions of the device can be varied by ±5% or by ±10% as necessary in order, for example, to achieve other nominal diameters.

The device in the exemplary embodiment mentioned has a length of 0.5 m. However, it can be provided with connecting elements at the ends of its tube, so that it can be connected to further corresponding devices to form a composite with an overall length of, for example, 5 to 8 m. Intermediate dimensions for the overall length can be achieved by the outer devices of this composite being shortened suitably.

It is otherwise also possible to arrange multiple devices one after another along a line in order to form a composite without the devices having to be connected to one another. Since all the devices are automatically supported on the hollow shaft, following the proper insertion of an appropriate “loose” composite, the advantages according to the invention are nevertheless achieved. The individual devices of the composite can be arranged immediately adjacent or at a distance from one another.

When a composite of multiple devices according to the invention is used in wind turbines, the required overall length frequently results from the overall length of an assembled hollow shaft, for example from the overall length of the hollow shaft of a gear mechanism which is coupled coaxially to a rotor hollow shaft. In particular in such a case, the internal diameter of the hollow shaft can vary; some of the devices can then preferably have a different external diameter as compared with the other devices of the composite. However, it is also possible that an additional guide tube with a similar internal diameter to that of the gear mechanism hollow shaft is arranged in the hollow shaft with the fundamentally greater internal diameter.

To explain the arrangement according to the invention and the wind turbine according to the invention, reference is made to the above embodiments.

### BRIEF DESCRIPTION OF THE DRAWINGS

The invention will now be described by way of example by using advantageous embodiments and with reference to the appended drawings, in which:

FIG. 1 shows a first exemplary embodiment of a device according to the invention;

FIGS. 2A-2C show schematic illustrations of the use of the device from FIG. 1;

FIG. 3 shows a second exemplary embodiment of a device according to the invention;

FIG. 4 shows a schematic sectional illustration of the device from FIG. 3;

FIG. 5 shows a schematic sectional illustration of variation of the device from FIG. 4;

FIG. 6 shows a schematic sectional illustration of another variation of the device from FIG. 4; and

FIG. 7 shows a schematic sectional illustration of a wind turbine with a device according to any one of the FIGS. 1-6.

### DETAILED DESCRIPTION

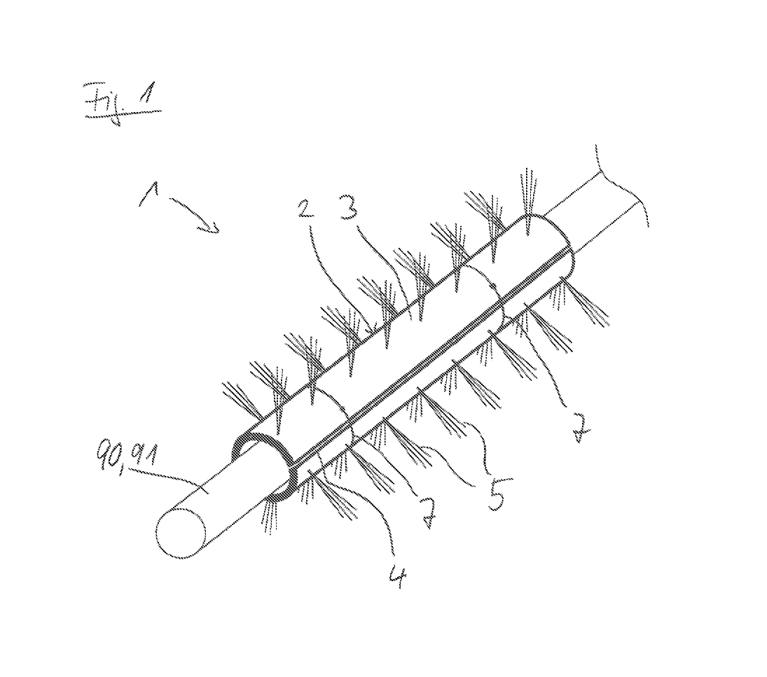

A first exemplary embodiment of a device 1 according to the invention is illustrated in FIG. 1.

The device 1 comprises a tube 2 of plastic, the wall 3 of which is provided over the entire tube length with a slot 4 parallel to the tube axis. The plastic is chosen to be elastic, such that the slot 4 can be deformed for the radial introduction of a line bundle 90 or an individual line 91 into the tube 2.

Arranged on the outer side of the tube 2, distributed in a regular grid in the longitudinal and circumferential direction are bristle tufts 5, which project at right angles to the outer side of the tube 2.

The longest bristles of the bristle tufts 5 define the external diameter of the device 1. This external diameter is chosen such that it is larger by 5% than the internal diameter of that hollow shaft into which the device 1 is to be inserted. Following the insertion into just this hollow shaft, the line bundle 90 is held centered by the bristle tufts 5, which rest on the inner wall of the hollow shaft.

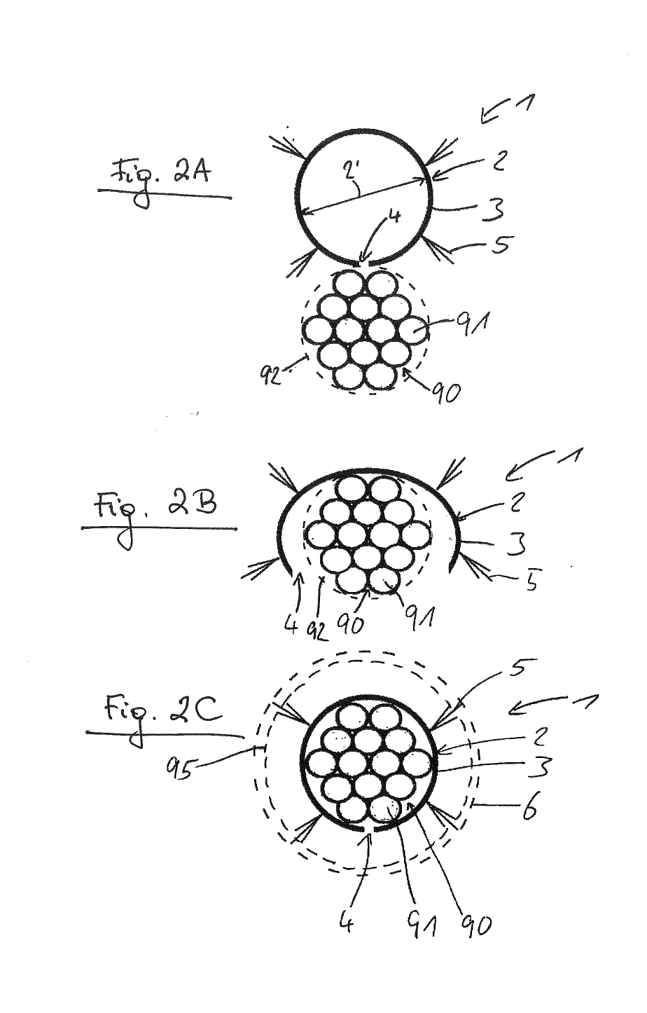

The introduction of lines 91 or a line bundle into the device 1 according to FIG. 1 is illustrated schematically in FIGS. 2A-2C. Starting from an initial state, in which the tube 2 is not deformed and has an internal diameter 2′ (FIG. 2A), the slot 4 is widened by elastic deformation of the tube wall 3 in such a way that the lines 91 laid together to form a line bundle 90 with an outer diameter 92, which is slightly greater than the internal diameter 2′ of the tube 2, can be introduced into the tube 2 in the radial direction relative to the tube axis (FIG. 2B). Then, the tube 2 returns into its original shape, which means that the tube 2 encloses the line bundle 90 (FIG. 2C).

In FIG. 2C, the external diameter 6 defined by the free ends of the bristle tufts 5—more accurately the respectively longest bristles thereof—is also illustrated. This external diameter 6 is larger than the inner diameter 95 of the rotating hollow shaft in which the device 1 is to be introduced. The tube 2 in the configuration illustrated in FIG. 2C can be secured with cable ties 7, which are laid around the tube 2 in bristle tuft-free sections (cf. FIG. 1).

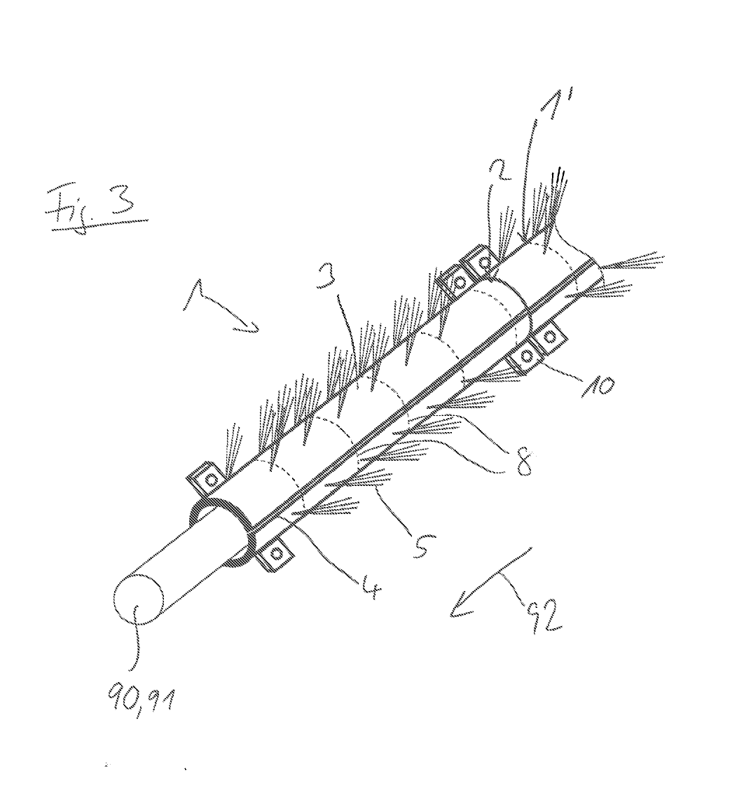

FIG. 3 shows a second exemplary embodiment of a device 1 according to the invention, which builds on the first exemplary embodiment. In the following text, only the differences from the first exemplary embodiment will therefore be explained and reference will be made below to the above explanations relating to FIGS. 1 and 2A-C.

The bristle tufts 5 in the exemplary embodiments according to FIG. 3 are no longer perpendicular with respect to the outer side of the tube 2 but are instead arranged inclined at an angle of less than 90° in the direction of the rotor axis. By means of an appropriate arrangement of the bristle tufts 5, the insertion of the device 1 into a hollow shaft in the direction indicated by arrow 92 is made easier.

Furthermore, the device 1 also has a plurality of bristle tuft-free sections 8, at which the device 1 can be severed as necessary. As a result, it is possible to reduce the length of the device 1 to a desired dimension. In just these sections 8, cable ties 7 for securing the device 1 to the line bundle 90 can also be arranged (cf. FIG. 1).

At the two ends of the tube 2, connecting elements 10 are also provided, via which the device 1 can be connected to adjacent devices 1′ as illustrated. The connecting elements 9 are implemented as projections with a passage hole, into which connecting clips (not illustrated) can be inserted.

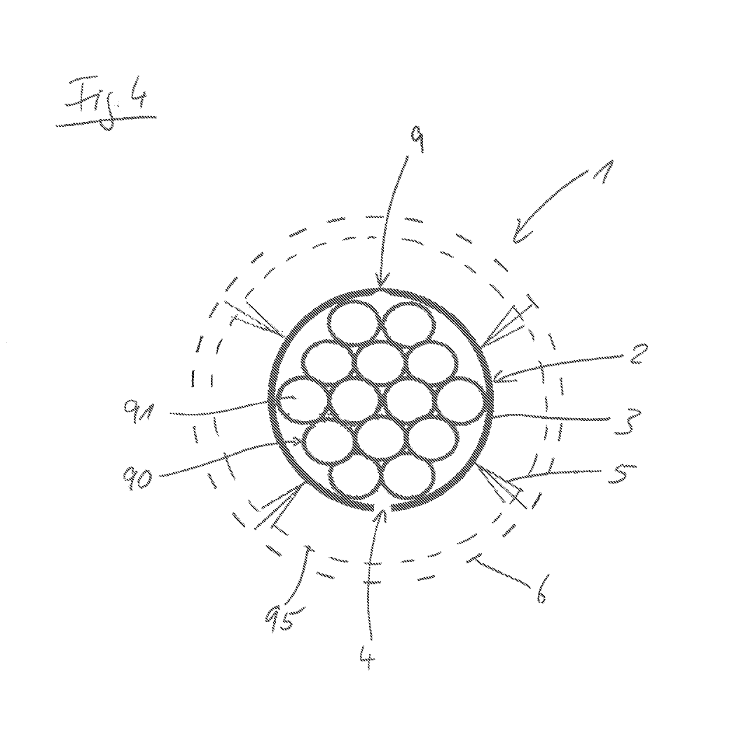

As can be seen in the sectional illustration according to FIG. 4, the wall 3 of the tube 2 has, at the point opposite the slot 4 in the circumferential direction, a tapering region 9 on the inside, which extends over the entire length the tube 2. By means of this tapering region 9, the widening of the slot 4 via elastic deformation of the tube 2 is made easier. The edges in the region of the tapering region 9 are all rounded in order to avoid damage to the lines 91 of the line bundle 90.

While the tube 2 of the first exemplary embodiment according to FIGS. 1 and 2A-C can be produced in an extrusion process, the tube of the second exemplary embodiment is an injection molding. The common feature of the two embodiments is that the bristle tufts 5 are attached to the tube 2 following fabrication of the latter. Furthermore, the tubes 2 are of such elastic plastic that the widening of the slot 4 described in conjunction with FIGS. 2A-C is possible without damage.

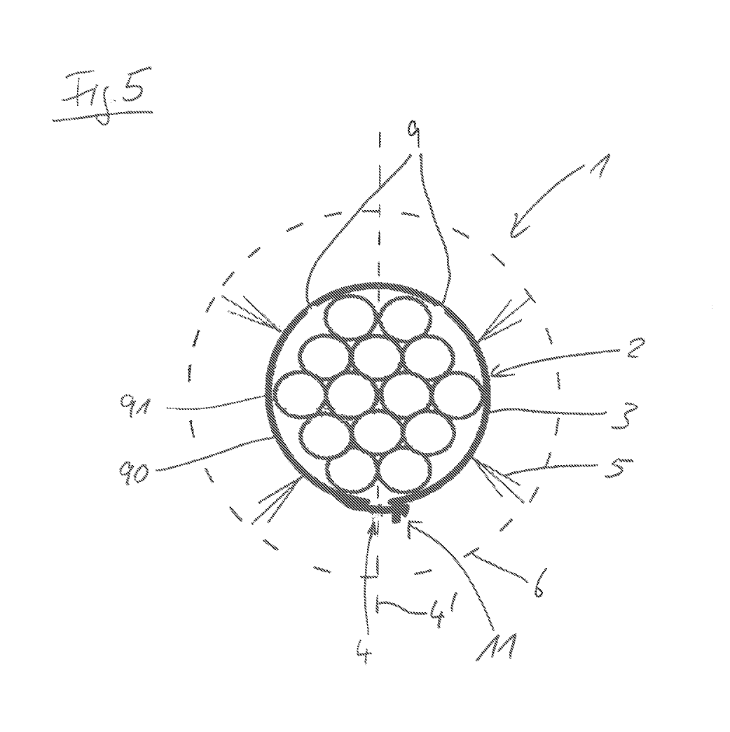

FIG. 5 shows a variation of the second exemplary embodiment according to FIGS. 3 and 4, where instead of a single tapering region 9, two tapering regions 9 are provided symmetrically to the median plane 4′ defined by the slot 4. Furthermore, the edges defining the slot 4 are provided with radii. For securing the device 1 enclosing the line bundle 90, a number of latching elements 11 are provided along the length of the device 1.

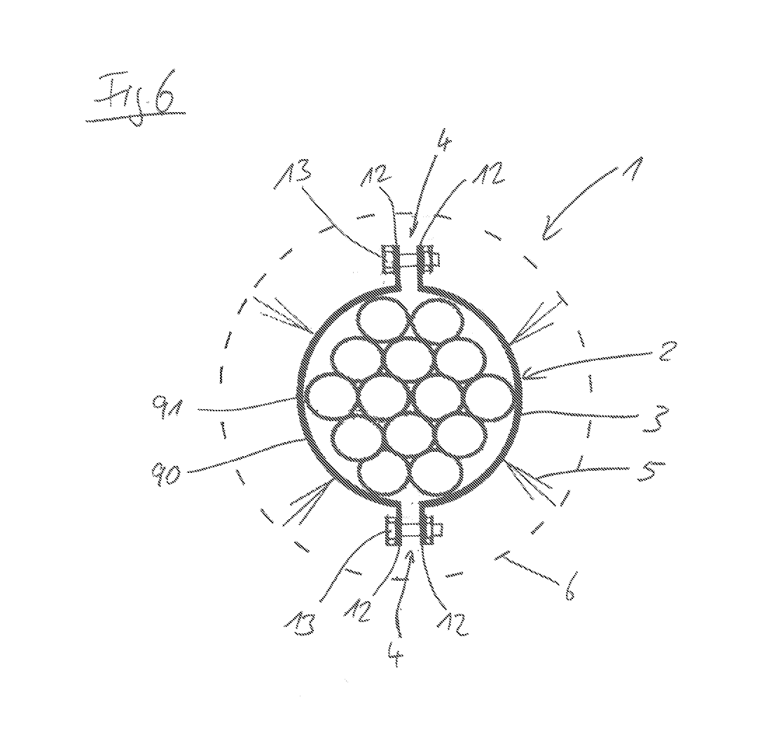

FIG. 6 shows yet another variation of the second exemplary embodiment according to FIGS. 3 and 4. The device 1 comprises two slots 4 located at opposite sides of the device 1. Each of the slots 4 is bordered by a flange 12 that allows for screw fixing 13 the two halves of the device 1 together.

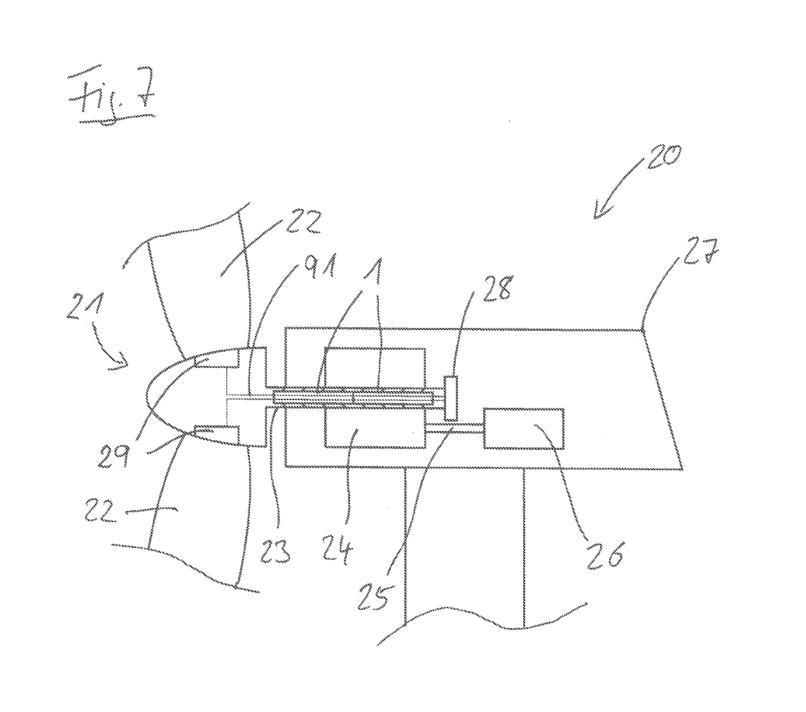

FIG. 7 shown the usage of the inventive device in a wind turbine 20. The wind turbine 20 has a rotor 21 with rotor blades 22 rotatably supported on a gondola 27 around a rotor shaft formed as a hollow shaft 23. The hollow shaft 23 passes through a gearbox 24 whose pinion shaft 25 drives a generator 26. Inside the hollow shaft 23, two inventive devices 1 are provided for centering lines 91 inside the hollow shaft 23. The lines 91 run from a slip ring arrangement 28 in the gondola 27 to pitch actuators 29 at the rotor blades 22.

1. A device for centering a line in a rotating hollow shaft (23) having an inside surface, said device comprising:
a tube (2) having a length and a wall (3) surrounding a central axis, said wall (3) having an outside surface and including a slot (4) substantially parallel with said axis and extending the entire length of the tube (2) said wall is deformable for the temporary widening of the slot (4) to allow the introduction of a line (91) in a radial direction through the slot (4) into the tube (2); and
bristle tufts (5) distributed on said outside surface of the wall (3) of said tube (2), said bristle tufts (5) comprising bristles having free ends projecting away from said outside surface and distributed about a circumference and along the length of said tube (2).

2. The device of claim 1, wherein said tube (2) is elastically deformable for the temporary widening of said slot (4).

3. The device of claim 1, wherein an outside diameter (6) of the device (1) is defined by the free ends of said bristle tufts (5), said outside diameter (6) is larger than an inside diameter of the rotating hollow shaft (23).

4. The device of claim 3, wherein said outside diameter (6) is 5% to 10% greater than the inside diameter of the rotating hollow shaft (23).

5. The device of claim 1, wherein said bristle tufts (5) project from said outside surface at an angle not equal to 90° with respect to said outside surface, and said bristles are inclined away from an expected direction of movement (92).

6. The device of claim 1, wherein said bristle tufts (5) are distributed uniformly over the length or about the circumference of the tube (2).

7. The device of claim 1, wherein said wall (3) has a thickness includes at least one tapering region (9) wherein said thickness is reduced, said at least one tapering region (9) extending the length of the tube (2) and parallel with said axis.

8. The device of claim 7, wherein said at least one tapering region (9) comprises a plurality of tapering regions (9) uniformly distributed about the circumference of said tube (2).

9. The device of claim 7, wherein each of said tapering regions includes longitudinally extending edges facing the inner side of said tube (2), and said longitudinally extending edges are de-burred or defined by a radius.

10. The device of claim 1, comprising a connecting element (10) for connecting the device to an axially adjacent second said device, said connecting element (10) is provided on the outside surface or an end of said tube (2).

11. The device of claim 1, wherein the tube (2) has sections (8) free of bristle tufts (5).

12. The device of claim 1, wherein said tube (2) is extruded or injection molded from plastic and is then provided with bristle tufts (5).

13. An arrangement comprising a hollow shaft (23) and at least one line (91) guided in the hollow shaft (23) by a device of claim 1, said device surrounding said at least one line (91) and the free ends of said bristles contacting an inside surface of said hollow shaft (23).

14. The arrangement of claim 13, wherein said tube (2) has an internal diameter that is less than or equal to the diameter of the at least one line (91) guided therein.

15. The arrangement of claim 13, comprising a plurality of the devices of claim 1 arranged one after another along a length of the at least one line (91).

16. The arrangement of claim 13, wherein said hollow shaft (23) is the rotor shaft of a wind turbine (20) and the at least one line (91) extends from a rotor of the wind turbine (20) through the rotor shaft to a gondola (27) of the wind turbine (20), said at least one line (91) is guided through the rotor shaft by at least one said device.
